(19) United States
(12) Patent Application Publication
(10) Pub. No.: US 2026/0328614 A1
(43) Pub. Date: Oct. 22, 2026

(54) SYSTEMS AND METHODS FOR DETERMINING ACOUSTIC SIGNATURE OF FIREARM AND PROJECTILE COMBINATION

(71) Applicant: ACCUSHOOT, INC., Corvallis, OR (US)

(72) Inventor: Rick Hangartner, Corvallis, OR (US)

(21) Appl. No.: 19/107,744

(22) PCT Filed: Sep. 4, 2023
(86) PCT No.: PCT/US2023/031951

§ 371 Date: Feb. 28, 2025

Related U.S. Application Data
(60) Provisional application No. 63/403,696, filed on Sep. 2, 2022.

(51) Int. Cl. G01H 17/00

(52) U.S. Cl. CPC G01H 17/00

(57) ABSTRACT

A system configured to receive an audio recording of a firearm discharge, compute a spectrogram based on the audio recording, and determine a specific firearm and ammunition combination associated with the audio recording. A deep neural network may be executed by one or more processors which may be trained to compute a spectrogram associated with the discharge audio, derive spectrogram weighting, and determine the firearm and/or ammunition combination that is associated with the audio recording. A trained input layer may be applied to the input data to increase the speed and accuracy of the determination.

### CROSS-REFERENCE

The present application claims the benefit of U.S. Provisional Application No. 63/403,696, filed Sep. 2, 2022, the entire disclosure of which is incorporated herein by reference.

### BACKGROUND

The field of the present disclosure is related to determining an acoustical signature of firearm and projectile combination. In many cases, it may be desirable to determine a particular firearm based upon acoustical information. Moreover, it may be further desirable to determine a specific ammunition and firearm combination. There are many use cases for such a system, for example, for determining the ordering of shots being fired during the commission of a crime, or to identify weaponry in a battlefield, or to identify separate shooters at a shooting range, such as for scoring purposes.

Historically, there has not been a system capable of identifying a specific firearm and/or ammunition combination, especially one that may rely only on consumer-grade audio recording equipment.

There is thus a need for a system and methods that can determine an acoustical signature for a firearm and one that can further determine a signature of a firearm and ammunition combination. There is a further need for a system that is capable of providing the aforementioned benefits using consumer-grade audio recording equipment, and in near-real time. These and other benefits will become readily apparent from the disclosure that follows.

### SUMMARY OF EMBODIMENTS

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for determining an acoustical signature of a firearm. The method also includes receiving an audio signal associated with a discharge of a firearm; generating a spectrogram associated with the audio signal; applying a mask to the spectrogram to generate a masked spectrogram input; executing a deep neural network configured to generate a classification of the masked spectrogram input; and determining, based at least on part on the masked spectrogram input, a firearm and an ammunition combination associated with the audio signal. Other embodiments of this aspect include corresponding computer systems, apparatus, and computer programs recorded on one or more computer storage devices, each configured to perform the actions of the methods.

Implementations may include one or more of the following features. The method where receiving the audio signal is performed by a microphone associated with a smart phone. The method is performed on the smart phone. The method may include training the mask on training data associated with the firearm and ammunition. The method may include receiving subsequent audio data associated with a discharge from a second firearm and determining that the discharge from the second firearm is not associated with the weapon and ammunition combination associated with the audio signal. The method may include receiving a plurality of audio samples associated with a plurality of firearm discharges and identifying, from the plurality of audio samples, individual ones of the plurality of audio samples that are associated with the firearm and ammunition combination. Implementations of the described techniques may include hardware, a method or process, or computer software on a computer-accessible medium.

One general aspect includes a system for determining an acoustical signature of a firearm a computing device having one or more processors, the one or more processors configured with instructions, may include: a spectrogram module configured to receive an audio signal and output a spectrogram associated with the audio signal; an attribute labeler configured to label the spectrogram associated with the audio signal with attributes to generate a labeled spectrogram; a weighting module configured to aggregate and weight the labeled spectrogram to generate a weighted spectrogram; and a deep neural network classifier configured to classify the weighted spectrogram to determine a firearm associated with the audio signal. Other embodiments of this aspect include corresponding computer systems, apparatus, and computer programs recorded on one or more computer storage devices, each configured to perform the actions of the methods.

Implementations may include one or more of the following features. The system where the computing device is a smart phone. The system may include a microphone configured to capture the audio signal. The system may include a camera configured to capture an audio/visual signal. The weighting module is further configured to train a weighting mask on the spectrogram to generate an acoustic signature for the firearm. The system is configured to differentiate a first acoustic signature associated with a first firearm from a second acoustic signature associated with a second firearm. Implementations of the described techniques may include hardware, a method or process, or computer software on a computer-accessible medium.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 illustrates a sample system for determining an acoustical signature, in accordance with some embodiments;

FIG. 2 illustrates a sample flow chart for pre-training a DNN, in accordance with some embodiments;

FIG. 3 illustrates a sample flow chart for deriving spectrogram weighting, in accordance with some embodiments; and

FIG. 4 illustrates a sample flow chart for classifying and determining an acoustic signature.

### DETAILED DESCRIPTION

According to some embodiments, a system is described that can quickly compute a signature for the acoustic sound of a shooter's weapon, firing specific ammunition, in a given environment, using consumer-grade audio recording equipment (e.g., an iPhone, a tablet, a telephone, a video camera). In some cases, the system can receive an input audio or audio/visual file and compute the signature of the firearm based on the sound in the captured recording. The recording may be captured by any suitable audio and/or video capture device, such as, without limitation, security cameras, traffic cameras, video cameras, television cameras, mobile device recorders such as smart phones or tablets, as well as other capture devices. In some cases, the capture devices are readily available consumer-grade recording devices. The acoustic signature may further include determining the make, model, silencer, ammo type, ammo manufacturer, and other characteristics of the weapon blast bast upon the acoustical signature from a discharged firearm.

This capability could be used to detect and separate the shooter's shots from those of other shooters on a typical shooting range, which may be useful, such as for automatic scoring. A version of this capability might be used to identify specific weapons and ammunition from sound recordings.

In some cases, the described solutions operate in near real-time on a single, consumer recording device such as a mobile phone using only a modest amount of training data. As used herein, the terms “real-time” or “near real time” are broad terms and in the context of this disclosure, relate to receiving input data, processing the input data, and outputting the results of the data analysis with little to no perceived latency by a human. In other words, a system as described herein that outputs analyzed data within less than one second is considered near-real time. A system that operates in real-time or near-real time may limit the amount of computation for machine-learning, or at least training models, that the method can use to characterize a particular weapon firing appropriate ammunition. In addition, there are methods which don't use ML techniques, by which we mean they don't adapt (“train”) a model on a large number of samples. Some of these other methods may work well but may also be more computationally intensive or shift the computational load to shot-identification time, such as, for example, searching a large dictionary of signatures for a “match.”

Prior approaches to utilizing artificial intelligence (AI) to analyze the sound of guns present a straightforward approach to using deep neural networks (DNNs) for classifying shot sounds by weapon and ammunition type. In prior approaches, the DNN must be pre-trained on a large number of shot sounds of each weapon and appropriate ammunition type. These sounds may not have been captured on the same recording device nor in the same shooting conditions. That potentially increases the generalization capability of the trained DNN instance for categorizing weapon and ammunition type regardless of environment and recording device. However, it decreases its capability to identify the shot sound of a specific weapon and ammunition type in an arbitrary environment using an arbitrary recording device.

Prior approaches describe a two-step approach to classification. For example, some prior approaches may use a pre-trained instance of a relatively generic pretrained DNN instance as an approximate classifier (predictor) and use an additional trainable step on the classifier output to improve the DNN prediction. In some cases, the DNN treats a finite length time segment of the time-varying spectrogram of the shot sound as an image and differentiates the pooled image for each weapon and ammunition pair from the pooled images of the other weapon and ammunition pairs. This approach has several drawbacks, including the use of a generic DNN instance that is not particularly adept at classifying sounds from different environments, or different ammunition.

According to some embodiments, the described system overlays a trainable weighting mask on an image created from a time segment of the time-varying spectrogram and a straightforward training method for adjusting the mask using just a few instances of shot sounds for the shooter's weapon and ammunition as recorded in a particular environment with a particular device. Training only the weighting mask is significantly less computationally intensive than training the DNN itself. Consequently, according to some embodiments, the DNN may not be trained, or may be trained to a much lesser degree than prior methods, and the weighting mask receives the training. This approach has several benefits.

For example, in abstract terms, the adjusted mask can be viewed as the signature for the combination of weapon, ammunition, environment and recording device. This signature is not used to search a catalog of signatures for that combination of factors, but to condition the spectrograms input to enhance the classification performance of the DNN for the weapon and ammunition in a particular environment using the given recording device. The enhanced DNN classification can then be used to improve detection and differentiation of shooter's shots from those of other shooters.

This approach has shown significant advantages in the intensity of the required computations, results in a much faster analysis, and can be used for numerous firearms in many different environments. For instance, because the training data set for a specific shooter is small, the weighting mask can be updated either in online fashion using stochastic gradient descent or in offline fashion using gradient descent. In other words, the training data may be for a specific shooter using a specific weapon and ammunition combination in a given environment, which results in a much smaller data set than if data points were agglomerated from numerous shooters in different environments.

In addition, both algorithms may estimate the gradient of the function computed by the DNN in each iteration of the weighting matrix update. While this is not computationally prohibitive, it may turn out that just the sign of the gradient or a roughly quantized version is sufficient. That simplification depends in most part on whether the DNN computes a monotonic increasing or decreasing function in each input. A significant body of literature exists investigating the properties of functions computed by DNNs. However, it's not easy to find a short answer to this question. In some instances, the DNN does if all of the internal layers use a linear or affine activation function and the output layer uses a monotonic non-decreasing activation function.

Accordingly, in some embodiments, the disclosed system is capable of quickly fingerprinting a weapon and ammunition pair in a particular environment using a specific recording device. In other words, the system and methods described herein can very quickly determine an acoustical signature of a firearm and ammunition combination in an environment. This allows the system to differentiate the analyzed acoustical signature from other firearm and ammunition combinations. This may be especially useful in a crowded shooting range where it is important to differentiate one shooter from another, such as, for example, in combination with a system that performs automatic target scoring. By being able to differentiate firearm and ammunition pairs, a scoring system will have a reduced number of false positives and missed shots because the system will be able to determine that a specific weapon and ammunition combination were utilized, which may be time wise matched with a hit on a target. In some examples, the system may be executed on a mobile computing device and used at a shooting range. Where the mobile computing device has a microphone pointed in the general direction of the shooter of interest, the shots fired by the shooter of interest will generally have an audio file that is dominated by shots fired by the shooter of interest, which may aid in determining whether a fired shot is from the shooter of interest. In some cases, the recording device (e.g., mobile computing device) has a microphone that is pointed down range, such as where the mobile computing device has a camera pointed at a target, such as for automated target scoring, in which case he audio from shots fired by the shooter of interest will have a volume that is more difficult to distinguish from other shooters at the range. In these cases, described embodiments may use training of a machine learning algorithm, or training of a weighting mask, to quickly differentiate shots fired by the intended shooters from all other shooters at the range.

In some cases, the classifier relies on feature extraction in the form of time-frequency spectrograms. Mel-frequency cepstral coefficients (MFCCs) vectors could be used as an alternative raw power spectrum density vector (PSDs) for the frequency representation of the spectrogram. Initially, Mel frequency cepstrums (MFCs) were developed for speech processing and the way information is thought to be encoded in the speech waveforms. In some cases, the MFC's may be applied to firearm fingerprinting purposes. As used throughout this disclosure a “firearm fingerprint” is used to refer to an acoustical signature, or a specific sound or image of sounds that identifies a specific firearm and ammunition combination.

In some cases, MFCCs may be generated through executing a series of steps, including, without limitation: i) window the signal segment and compute the Fast Fourier Transform (FFT) of the signal segment, ii) combine linear FFT coefficients into the MEL frequency filter bank coefficients, iii) take the logs of those coefficients, and iv) compute the discrete cosine transform (DCT) of the log MEL filter bank coefficients. The FFT of the signal segment generally results in a peak at the applied frequency along with other peaks, referred to as side lobes, which are typically on either side of the peak frequency. The DCT, in some cases, expresses a finite sequence of data points in terms of a sum of cosine functions oscillating at different frequencies. In some cases, fewer or more than the disclosed steps may be implemented to arrive at firearm fingerprints based on shot sounds. For instance, in some cases, only steps i), ii), and iii) described above may be used for shot sounds.

According to some embodiments, MFCC or PSD coefficients may be used as inputs to a DNN trained to classify time-frequency spectrograms into some number of independent categories. For instance, the MFCC and/or PSD coefficients may input two categories as in the proposal, or some number of categories corresponding to (weapon, ammo) pairs, or some larger number of categories corresponding to tuples of k>2 attributes.

In some cases, the DNN may place a new shot sound “in the neighborhood of” whatever class the maximal classifier output of all the classifier outputs represents. For example, a shot sound may be initially classified through a nearest neighbor approach, such as a k-NN algorithm. Subsequent analysis may further classify the shot sound.

Inner layers of the DNN may represent different sets of attributes of the input. These may likewise be used for classifying the shot sounds and training.

From an optimization theory perspective, training the DNN essentially defines a surface with multiple local optima and the DNN can be thought of as directing a new input to the most appropriate local optimum. In some embodiments, following the pre-trained DNN with one or more trainable layers might be thought of as extracting a different set of more optimum attributes for shot sounds.

In some cases, preceding the pre-trained DNN with a trainable layer, may include, in some cases, weighting coefficients, might be thought of as adjusting the pre-trained DNN so that the shooter's shots of interesting are the most positive examples of all shots in the pre-trained DNN places “in the neighborhood of” whatever class the maximal classifier output of all the classifier outputs represents. In some cases, the decision threshold may be adjusted to optimize the confusion matrix for the training dataset used to adjust the trainable input layer or another test dataset for some useful criteria.

According to some embodiments, the FFT of a windowed segment of the shot audio can be computed in O(n log n) time. Computing MFCCs has the same time order but includes computing two O(n log n) operations. In some cases, the MFCCs may not be significantly better than FFTs and they may be omitted.

According to some embodiments, the MEL frequency log spectrum (omit the discrete cosine transform (DCT) yielding the cepstrum) might be an improvement over raw FFTs with only O(n) extra computation cost. Therefore, in some examples, the MEL frequency log spectrum is used rather than the DCT yielding the cepstrum.

In general, there is no fast form for computing the function computed by a DNN (composed of layers of convolutional neural networks (CNNs)) like the FFT. The FFT takes advantage of regularities in the FFT kernel that generally won't exist in a composition of essentially arbitrary CNNs. However, examples described herein have an FFT of the input time signal, and the pre-trained DNN consisting of CNNs may be implemented in the frequency domain.

As a non-limiting example, the following DNN-based quickly-trainable category recognizer may be implemented to quickly determine an acoustic signature of a firearm and ammunition combination.

Let f: R^{M}→R^{K} denote the analog transformation by a trained deep neural net from a real-valued M-dimensional input vector to a K-dimensional vector of class probabilities. A final discrete output mapping Ψ: R^{K}→N^{≤K} selects the most probable of the K classes.

The system may be configured to expand the trained DNN into an enhanced binary classifier for class k. In some cases, the system may add a rapidly trainable input stage to the DNN implemented as the Hadamard product “⊙” of a weighting matrix W and the input vector x. In some cases, the Hadamard product is a binary operation that takes in two matrices, such as a weighting matrix W and the input vector x, and returns a matrix of the multiplied corresponding elements. The system can then follow the DNN class probability vector output with a selector function:

Γ: R^{K}×N^{≤K}→R that provides the single class probability of class k. The enhanced DNN may implement the function:

y(n)=Γ(f(W⊙x(n)); k)

Suppose we have a set of additional input vectors ζ={Z₁, . . . , Z_{M}}, all instances of the same class k. The system can be tuned to better recognize similar instances of class k through any of a number of suitable ways. For example, one method is online learning that is typically used for large training datasets. For online learning, we initially set W=1 and then update it sequentially for the vectors in ζ using stochastic gradient descent as:

Wₗ₊₁=relu[Wₗ+α·(d(n)−Γ(f(Wₗ⊙zᵢ); k))·(∇xf(Wₗ [symbol] zᵢ))·zᵢ)] i=1, . . . , M
where 0<α<1 is an adaption constant that weights the relative contribution of ζ to W. The target value d(n)=1.0 for every vector in ζ. The iteration is performed until it converges for each z in ζ. Here relu[ . . . ] denotes elementwise relu() of the argument matrix.

A firearm discharge results in multiple acoustic events, such as, for example, the muzzle blast created by the expansion of gases within the chamber and exiting through the barrel, and the ballistic shockwave generated by the projectile, which, in most cases, is supersonic, but may also be subsonic in some cases. The acoustic events are the result of variables that generate the firearm signature, and may include the firearm type, make, model, barrel length, ammunition type, powder quantity and identity, projectile weight, and projectile shape, among others.

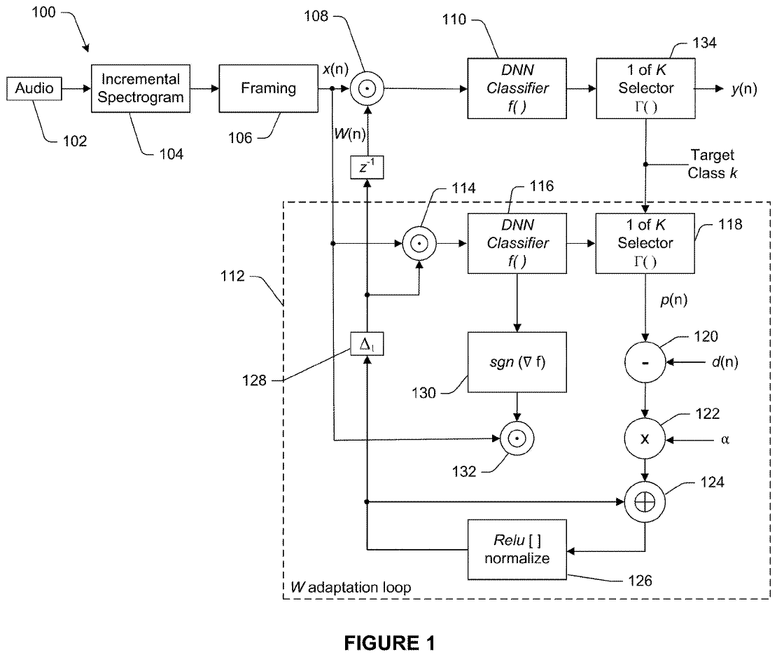

With reference to FIG. 1, which illustrates an example system 100 that uses online learning, audio 102 is received and is converted to an incremental spectrogram 104. The spectrogram 104 is framed 106, such as by a time window, and used to determine MFCCs, such as by determining the FFT of the windowed signal, combining linear FFT coefficients into the MEL frequency filter bank coefficient, determining the logs of the coefficients, and determining the DCT of the log MEL filter bank coefficients. The determined MFCC's can be entered into a rapidly trainable input stage 108 and then delivered to a DNN multi-class classifier 110. The selector 134 determines the classifier output k with the highest class probability to classify a shot. The rapidly trainable input stage 108 may be referred to as a trainable weighting mask, or just mask. The mask may be adjusted using instances of shot sounds for the shooter's weapon and ammunition as recorded in a particular environment. In some cases, training only the weighting mask is significantly less computationally intensive than training the DNN. The trained (e.g., adjusted) weighing mask may represent the signature for the combination of weapon, ammunition, environment, and recording device. This signature is not necessarily used to search a catalog of signatures, but rather, is used to condition the spectrograms input to enhance the classification performance of the DNN for the weapon and ammunition in a particular environment using the given recording device. In some cases, the training dataset for a specific shooter (e.g., a specific firearm and ammunition combination) is small, therefore the weighting mask can be updated either using online approaches, such as by using stochastic gradient descent, or offline such as by using gradient descent techniques.

Inner layers of the DNN classifier 110 may represent different sets of attributes of the input. In some cases, the DNN is trained to define a surface with multiple local optima and the DNN can act to direct a new input to the most appropriate local optimum. The enhanced DNN classification can then be used to improve detection and differentiation of a shots from one weapon from those of other shooters.

The weighting mask W of the input stage 108 to the pre-trained DNN classifier 110 may be adapted by an online learning loop 112 that optimizes the weighting mask W.

The online learning loop 112 includes a copy 114, 116, and 118 of the shot classifier 108, 110, and 134. When a new shot nis detected, the subtractor 120 in the online learning loop 112 compares the result of the selected output k from the copy of shot classifier 114, 116, and 118 to the expected classification d(n)=1.0 to compute a classification error term.

Block 130 of the adaption loop computes the vector sign of the gradient of the DNN output with respect to spectrogram input for the current output spectrogram x(n) from the framing block 106.

A raw incremental adjustment to the current weighting vector Wᵢ(n) is then computed by the Hadamard multiplier 132 as the product of the current shot spectrogram from the framer 106 and the sign vector of the classifier gradient 130. The vector multiplier 122 then scales the raw incremental adjustment to the weight vector Wᵢ(n) by an arbitrary value α.

Finally, the vector adder 124 computes a preliminary updated weight by adding the current incremental adjustment to the current Wᵢ(n). This preliminary weight is transformed by the vector relu[ ] operation 126 to an updated weight vector Wᵢ₊₁(n).

The weight adaption loop 112 just described is iterated, as symbolized by the delta operator 128, until the weight vector converges, for example |Wᵢ(n)—Wᵢ₊₁(n)|≤δ. The result Wᵢ₊₁(n) is then selected as the weight vector W(n+1) for classifying the next shot.

Offline learning may be used, such as when ζ is small. In some cases, offline learning may be initiated by setting W=I and updating it using gradient descent as:

Wₗ₊₁=relu[Wₗ+α·1/M, for i=1 to M: Σ{(d(n)−Γ(f(Wₗ⊙zᵢ); k)·(∇ₓf(Wₗ⊙zᵢ)⊙zᵢ)}]

In some cases, offline learning may require about the same amount of computations as online learning. However, online learning has the advantage over offline learning that stochastic gradient descent doesn't require accessing the entire training dataset ζ in every iteration of the update function while offline learning does. Offline learning offers the advantage of finding a local optimum while online learning may only approximate it.

While the gradient ∇ₓf evaluated at the current argument Wₗ⊙zᵢ is not excessively costly to compute, it may be sufficient to pre-compute sgn(∇ₓf(1)) or sgn(∇ₓf (1·β)) where 1 is the unit vector if the DNN normalizes the input. In some cases, this may significantly simplify offline learning in this situation at the cost of only approximating a local optimum like online learning.

While there are systems aimed at enhancing a DNN to classify shots, they do so by adding layers to the output of a pre-trained network to customize it to a particular task. The pre-trained network extracts many levels of increasingly abstract features, such as from images, and the additional trainable layers are used to focus on a problem of interest. In contrast, many of the systems and methods described herein function in a much different way that results in a system that is more efficient, much quicker, and more accurate. The systems described herein, in many cases, only add a single layer to the input of a pre-trained network. In some use cases, a camera is pointed at a target rather than focused on a shooter, and the camera and microphone pick up other shots without being able to natively determine that the discharge came from a shooter of interest. The acoustical signature is generated quickly and, in many cases, is performed on a mobile device that includes a camera and a microphone (e.g., smartphone). The mobile device may execute instructions (e.g., an application) that includes the components and systems described herein so that the classification and acoustical signature determination is performed on the mobile device. In some cases, the pre-trained network may be trained on a relatively encompassing universe of shots. The trainable input layer may pre-distort the input data to achieve a highly probable recognition by the pre-trained network of the particular weapon with ammunition and environment. This may then increase the likelihood of detecting the shot of interest and rejecting all other shots.

According to some embodiments, the systems and methods described herein will converge to a useful weighting mask where the gradient of the function computed by the DNN is monotonic non-decreasing or monotonic non-increasing in each input.

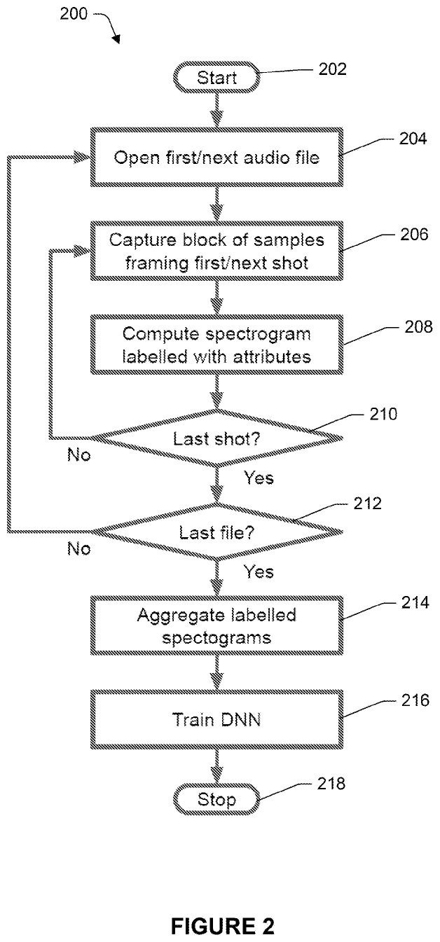

With reference to FIG. 2, which illustrates pretraining a DNN, a process 200 begins 202 and at block 204 an audio file is opened, which may be a first audio file, or a next or subsequent audio file. The audio file is used and the system, at step 206, captures a block of samples framing a first and/or next shot. In other words, each shot is windowed in a time-bound sample. At block 208, a spectrogram associated with the samples is generated and labeled with attributes.

At block 210, the system determines whether the most recent sample is associated with a last shot, and if not, the system returns to block 206 to capture a block of samples associated with a subsequent shot. If so, the system proceeds to block 212 and determines whether the labeled spectrogram created at block 208 is the last file. If not, the system returns to block 204 to open or capture a next audio file. If the system determines the most recent file is the last file, the system proceeds to block 214 where the labelled spectrograms are aggregated. At block 216, the DNN is trained on the labeled spectrograms. The system stops at block 218 with a trained DNN.

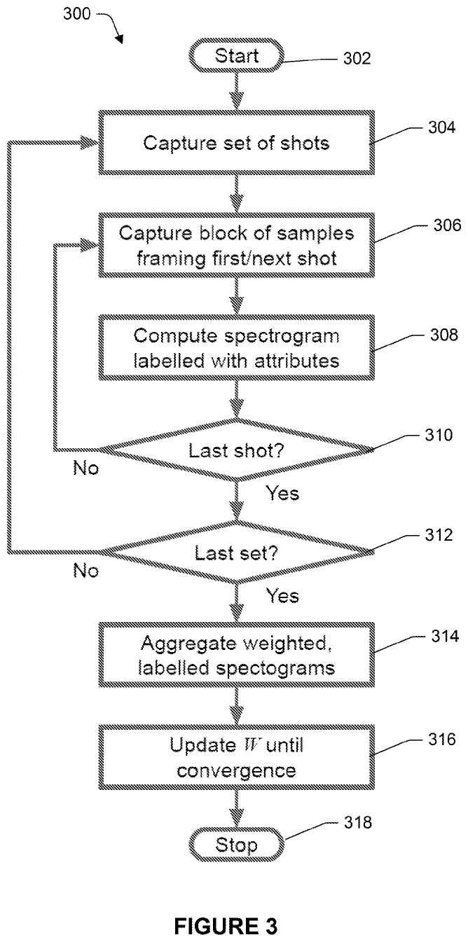

With reference to FIG. 3, which illustrates deriving spectrogram weighting, a process 300 begins 302 and at block 304 a set of shots is captured. The shots may be captured by an audio and/or video recording device, or may include opening a file associated with one or more shots. At block 306, the system captures a block of samples framing a first and/or next shot. In other words, each shot is windowed in a time-bound sample. At block 308, a spectrogram associated with the samples is created and labeled with attributes.

At block 310, the system determines whether the most recent spectrogram is associated with a last shot, and if not, the system returns to block 306 to capture a block of samples associated with a subsequent shot. If so, the system proceeds to block 312 and determines whether the labeled spectrogram created at block 308 is the last set. If not, the system returns to block 304 to capture a next set of shots. If the system determines the most recent file is the last file, the system proceeds to block 314 where the labelled spectrograms are aggregated. At block 316, the system updates W (weighting) until the value converges. The system stops at block 218 with a spectrogram weighting.

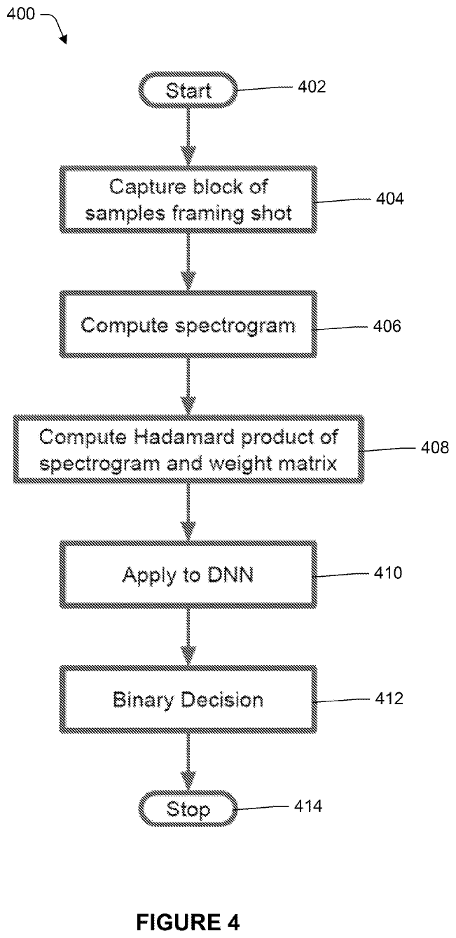

With reference to FIG. 4, a process for classifying a shot 400 is illustrated. The process begins at bock 402, and at block 404, the system captures a block of samples framing a shot. At block 406, the system determines a spectrogram associated with the block of samples. At block 408, the system determines a Hadamard product of the spectrogram and weight matrix. At block 410, the Hadamard product of the spectrogram and weight matrix is applied to the DNN. At block 412, the system makes a binary decision, such as the shot was either associated with the signature of the firearm in question or it was not. In some cases, the system is able to identify the type of firearm and the ammunition that was fired through the firearm. For instance, when receiving an audio sample, the system, without any prior knowledge of the fiream in question, can determine that the acoustic signature of the firearm in the audio sample corresponds with a 230 grain round-nose projectile fired from a Beretta 0.45ACP. At block 414, the process stops.

The system may include one or more processors and one or more computer readable media that may store various modules, applications, programs, or other data. The computer-readable media may include instructions that, when executed by the one or more processors, cause the processors to perform the operations described herein for the system.

In some implementations, the processor(s) may include a central processing unit (CPU), a graphical processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which alsomay store program modules, program data, and/or one or more operating systems. The one or more control systems, computer controller and remote control, may include one or more cores.

Embodiments may be provided as a computer program product including a non-transitory machine-readable storage medium having stored thereon instructions (in compressed or uncompressed form) that may be used to program a computer (or other electronic device) to perform processes or methods described herein. The computer-readable media may include volatile and/or nonvolatile memory, removable and non-removable media implemented in any method or technology for storage of information, such as computer-readable instructions, data structures, program modules, or other data. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. In some examples, the process is performed on a mobile electronic device, such as a smartphone, tablet, laptop or other mobile computing device. For example, a smartphone may download and run an application (app) that configures the smartphone to utilize a built-in microphone and/or video camera to capture sounds and/or audio-video associated with a firearm and then perform the methods described herein to classify the shot and determine whether the shot was associated with a specific firearm and ammunition combination.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the description do not preclude additional components and are to be construed as open ended.

The specification and annexed drawings disclose examples of systems, apparatus, devices, and techniques that may provide a system and method for determining acoustical signatures of discharged firearms. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What I claim is:

1. A method for determining an acoustical signature of a firearm, comprising:
receiving an audio signal associated with a discharge of a firearm;
generating a spectrogram associated with the audio signal;
applying a mask to the spectrogram to generate a masked spectrogram input;
executing a deep neural network configured to generate a classification of the masked spectrogram input; and
determining, based at least on part on the masked spectrogram input, a firearm and an ammunition combination associated with the audio signal.

2. The method of claim 1, wherein receiving the audio signal is performed by a microphone associated with a smart phone.

3. The method of claim 2, wherein the method is performed on the smart phone.

4. The method of claim 1, further comprising training the mask on training data associated with the firearm and ammunition.

5. The method of claim 4, wherein the mask is a Hadamard product of a weighting matrix and an input vector.

6. The method of claim 1, further comprising receiving subsequent audio data associated with a discharge from a second firearm and determining that the discharge from the second firearm is not associated with the firearm and ammunition combination associated with the audio signal.

7. The method of claim 1, further comprising receiving a plurality of audio samples associated with a plurality of firearm discharges and identifying, from the plurality of audio samples, individual ones of the plurality of audio samples that are associated with the firearm and ammunition combination.

8. A system for determining an acoustical signature of a firearm, comprising:
a computing device having one or more processors, the one or more processors configured with instructions, comprising:
a spectrogram module configured to receive an audio signal and output a spectrogram associated with the audio signal;
an attribute labeler configured to label the spectrogram associated with the audio signal with attributes to generate a labeled spectrogram;
a weighting module configured to aggregate and weight the labeled spectrogram to generate a weighted spectrogram; and
a deep neural network classifier configured to classify the weighted spectrogram to determine a firearm associated with the audio signal.

9. The system of claim 8, wherein the computing device is a smart phone.

10. The system of claim 8, further comprising a microphone configured to capture the audio signal.

11. The system of claim 8, further comprising a camera configured to capture an audio/visual signal.

12. The system of claim 8, wherein the weighting module is further configured to train a weighting mask on the spectrogram to generate an acoustic signature for the firearm.

13. The system of claim 12, wherein the weighting mask is generated by determining a Hadamard product of a weighting matrix and in input vector to generate the weighted spectrogram.

14. The system of claim 8, wherein the system is configured to differentiate a first acoustic signature associated with a first firearm from a second acoustic signature associated with a second firearm.
